(19) United States
(12) Patent Application Publication
(10) Pub. No.: US 2025/0022447 A1
(43) Pub. Date: Jan. 16, 2025

(54) Piano chord producing bars

(71) Applicant: Brady William Rambeau, Oceanside, CA (US)

(72) Inventor: Brady William Rambeau, Oceanside, CA (US)

(21) Appl. No.: 18/445,324

(22) Filed: Jul. 10, 2023

(51) Int. Cl. G10H 1/34; G10H 1/00

(52) U.S. Cl. CPC G10H 1/344; G10H 1/0016; G10H 2220/061; G10H 2220/295

(57) ABSTRACT

This disclosure concerns an input keyboard which works in unison with a compatible operating program to produce piano chords. The keyboard incorporates strategically placed pairs of actuator switches that are tied together in unison by a lengthways-positioned rectangular bar that is attached on top of each one of the actuator switches by a flexible fastener means with each actuator switch being attached directly underneath each end of the rectangular bar. This conglomeration is referred to as a Piano Chord Producing Bar. Each piano chord producing bar is programmed to produce full or partial piano chords when depressed. Piano chord producing bars are plurally arranged in horizontal parallel rows that extend from the left to the right side of the keyboard. Piano Chord Producing Bars keyboards with their compatible operating programs can be incorporated into electronic keyboard musical instruments or used as controller keyboards for input into various devices.

### BACKGROUND

### Technical Field

The disclosure relates to music producing systems and, more particularly, to a keyboard which works in unison with a compatible operating program to produce musical arrangements.

### Related Art

In accordance with the prior art, several types of electronic machines such as electric pianos, synthesizers, computers, controllers and input keyboards utilize operating programs that produce computer generated piano chord sequences.

Playing piano chords on a piano's keyboard originally required the player to depress all the proper piano keys to play a particular key of music piano chord.

Some modern electronic pianos incorporate a program that will produce a piano chord of a particular key of music with the pressing down of just one piano key. That piano chord producing program can only be utilized when the electronic piano is running in an Auto-accompaniment mode and it will not allow the piano player to play in several rows or in several octaves of the same piano chord all at the same time.

Previously used manual and program generated piano chord systems are limited in the “hands-on” approach to playing piano chords.

The machine disclosed in the present invention utilizes a simple to use keyboard which is operated in unison with a compatible operating program to play piano chords and individual music notes in any amount of musical instrument's voices. This keyboard will incorporate any amount of individual rows with any amount of piano chord producing bars which are each individually tunable to play synchronized full or partial piano chords and individual music notes in any desired key of music and in any amount of musical instrument's voices when they are pressed down.

Patents illustrative of some of these prior art machines and systems include U.S. Pat. Nos. 2,972,922; 6,211,452; 3,872,765; 5,260,510; 5,440,071; 10,818,279; 5,575,576; 6,590,508; 3,267,248; 9,165,476; 9,076,419 and 6,501,011.

### SUMMARY

A rectangular bar is fastened lengthways onto the tops of two actuator switches that are strategically mounted upon a keyboard's top surface. These two actuator switches and the rectangular bar work together in unison for input purposes. The rectangular bar is fastened down onto the top of each one of the two actuator switches by any type of a flexible fastener means with each actuator switch being strategically located directly underneath each end of the two opposing ends of the rectangular bar. This conglomeration is referenced as a Piano Chord Producing Bar.

Lights are mounted on the keyboard's surface underneath each piano chord producing bar in a strategic location between each one of the two actuator switches.

Each individual piano chord producing bar can be programmed to play music notes in any octave, in any key of music, in any amount of musical instrument's voices and in any amounts of properly synchronized full or partial piano chords.

Piano chord producing bars are plurally arranged in horizontal parallel rows which extend lengthways from the left side of the keyboard to the right side of the keyboard.

Each one of the individual rows of piano chord producing bars can be programmed to play piano chords and music notes in any particular key of music and in the musical instrument's voices that are specifically assigned to the individual row.

A keyboard may contain any amount of individual rows of piano chord producing bars.

A keyboard may contain as many piano chord producing bars per row as desired.

The keyboard may be covered with a protective membrane.

Piano Chord Producing Bars keyboards with their compatible operating programs can be incorporated into electronic keyboard musical instruments.

Piano Chord Producing Bars keyboards with their compatible operating programs can be incorporated into controller keyboards for input into various devices.

Because each individual piano chord producing bar can be programmed to play as many piano chords as desired, electronic keyboard musical instruments and controller keyboards utilizing this compressed chords technique can be made in smaller widths than the past produced products in their fields.

Controller keyboards using piano chord producing bars are simple in design, inexpensive to manufacture and cost effective to customers when using them with a personal computer and sound system which eliminates the need to purchase a bulky, expensive controller piano or electronic piano instrument.

Piano chord producing bars keyboards are extremely easy to play providing instant gratification for an inexperienced piano player and the rectangular bars can also be made in any color for easily playing songs which are written in color. The rectangular bars can also textured for touch place referencing to aid the visually impaired.

### BRIEF DESCRIPTION OF THE DRAWINGS

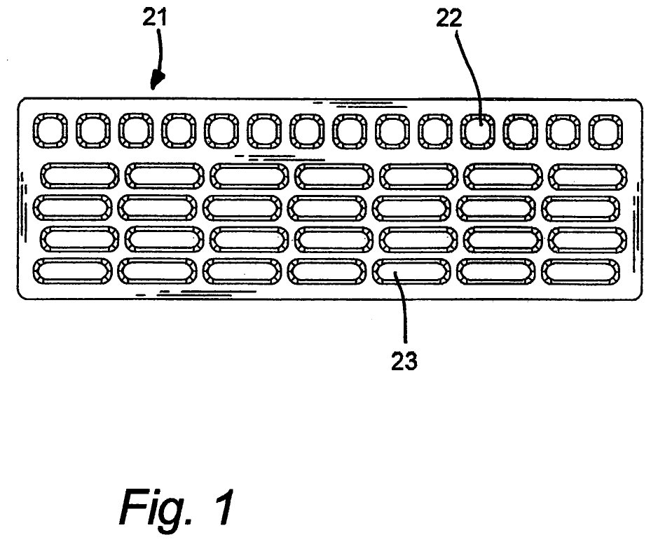

(FIG. 1 top view) is a drawing of a controller keyboard that has a top row of fourteen plurally placed actuator switches.

Below that row are four horizontally parallel rows with each row containing seven plurally placed rectangular bars.

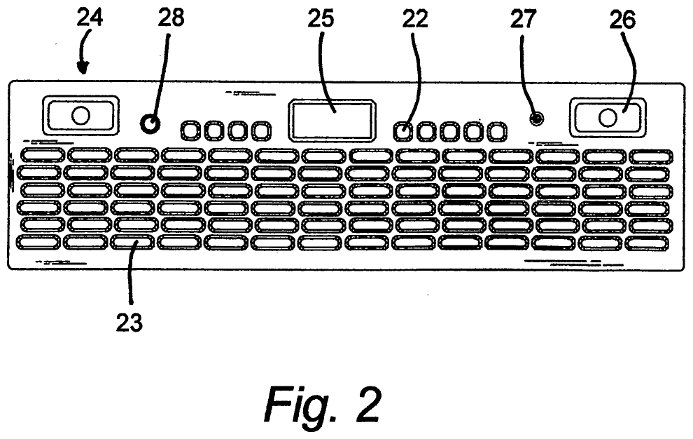

(FIG. 2 top view) is a drawing of an electronic keyboard musical instrument that has a top row containing a speaker, a volume control, four actuator switches, a display screen, five actuator switches, an on/off button, and another speaker. Placed below that top row are six horizontally parallel rows with each one of those rows containing fourteen plurally placed rectangular bars.

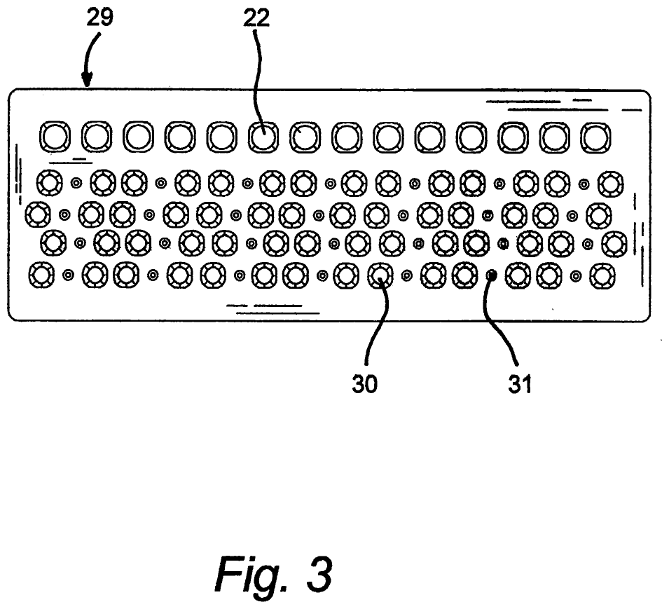

(FIG. 3 top view) is a drawing of controller keyboard that has a top row of fourteen plurally placed actuator switches. Placed below that top row are four horizontally parallel rows with each one of those rows containing in succession an actuator switch, then an LED light, then an actuator switch.

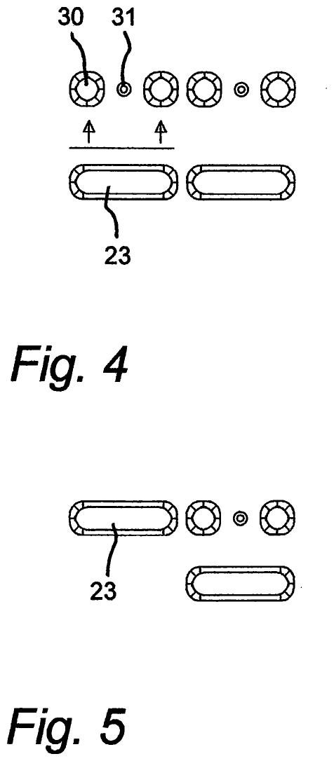

(FIG. 4 top view) is a drawing with a top row that contains an actuator switch, then an LED light, then an actuator switch, then another actuator switch, then an LED light, then an actuator switch. Below that top row is a set of directional arrows. On the bottom row is a horizontally placed rectangular bar, then another horizontally placed rectangular bar.

(FIG. 5 top view) is a drawing with a top row that contains a horizontally placed rectangular bar, then an actuator switch, then an LED light, then an actuator switch.

The bottom row contains a horizontally placed rectangular bar.

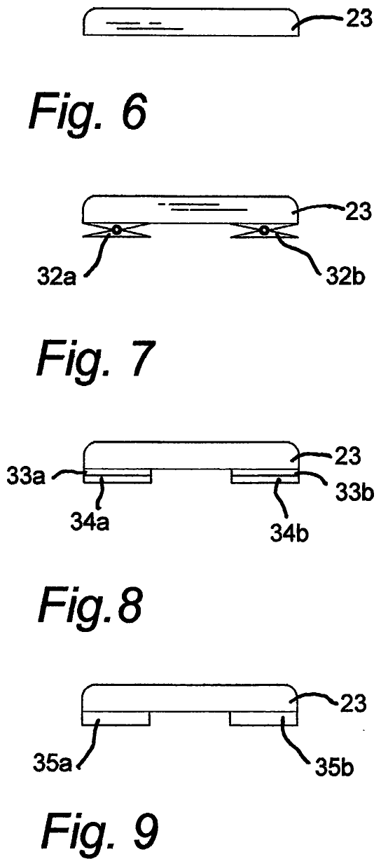

(FIG. 6 side view) is a drawing of a horizontally placed rectangular bar.

(FIG. 7 side view) is a drawing of a horizontally placed rectangular bar with a swiveling fastener attached underneath each one of it's ends.

(FIG. 8 side view) is a drawing of a horizontally placed rectangular bar with a hook and loop fastener attached underneath each one of it's ends.

(FIG. 9 side view) is a drawing of a horizontally placed rectangular bar with a flexible membrane attached underneath each one of it's ends.

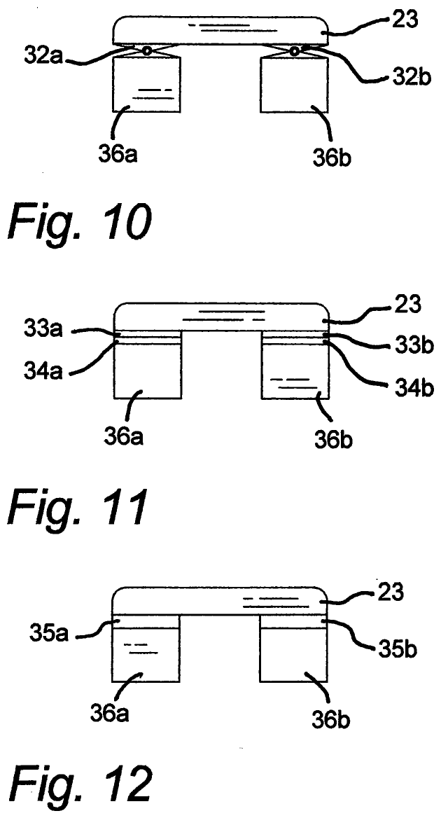

(FIG. 10 side view) is a drawing of a horizontally placed rectangular bar with a swiveling fastener attached underneath each one of it's ends. An actuator switch is shown attached underneath each one of the two swiveling fasteners.

(FIG. 11 side view) is a drawing of a horizontally placed rectangular bar with a hook and loop fastener attached underneath each one of it's ends. An actuator switch is shown attached underneath each of one the two hook and loop fasteners.

(FIG. 12 side view) is a drawing of a horizontally placed rectangular bar with a flexible membrane attached underneath each one of it's ends. An actuator switch is shown attached underneath each of one the two flexible membranes.

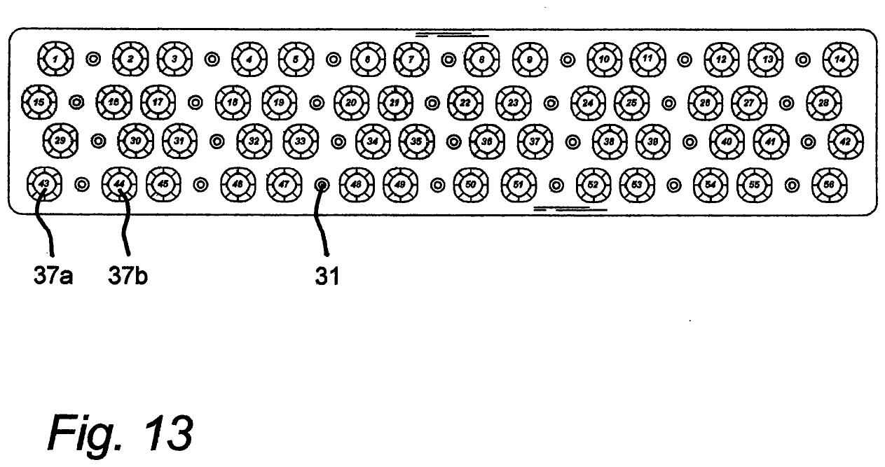

(FIG. 13 top view) is a drawing of the section of the keyboard area that contains LED lights and the actuator switches that will hold the rectangular bars.

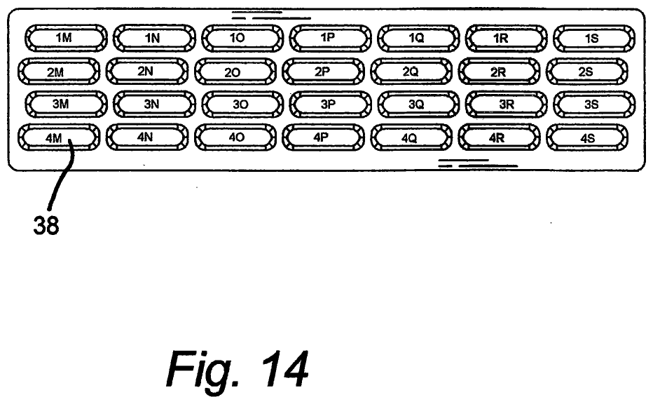

(FIG. 14 top view) is a drawing of four rows of rectangular bars that have been reference numbered for the operating program.

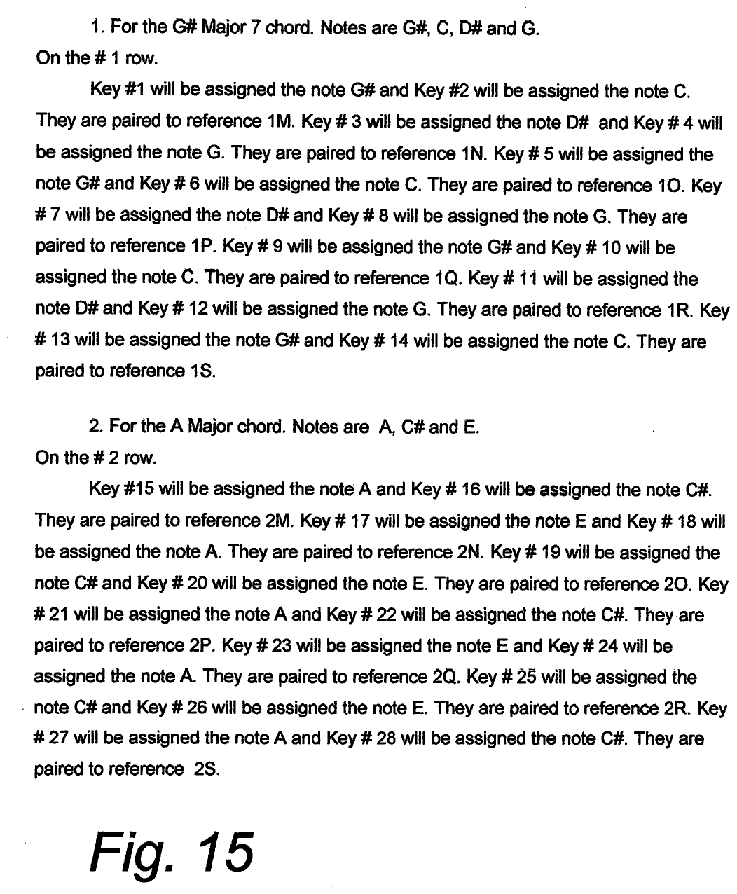

(FIG. 15 text) shows samples of instructions that explain the programming procedure to assign each correct music note to each correct actuator switch for each particular piano chord to be played by the piano chord producing bars.

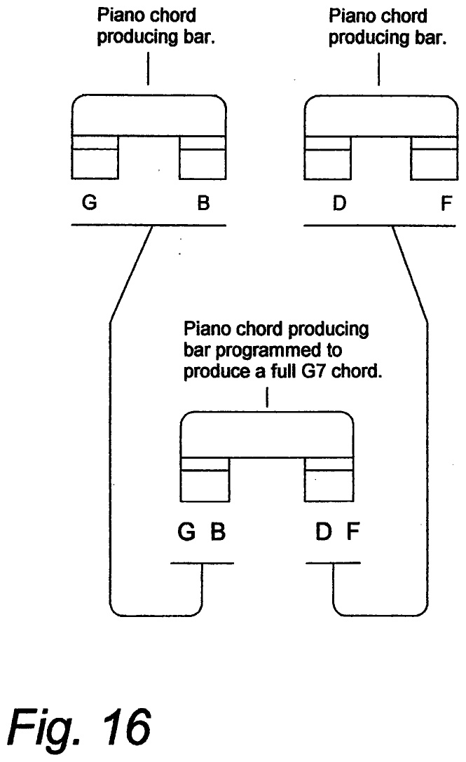

(FIG. 16 side view) is a drawing showing how the operating program for piano chord producing bars works to re-assign music notes to piano chord producing bars.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments. However, a myriad of other embodiments which will not be expressly described will be readily understood by those having skill in the art upon a thorough review hereof. Accordingly, any reviewer of the instant disclosure should interpret the scope of the invention by the claims, and such scope shall not be limited by the embodiments described and illustrated herein.

In a general embodiment, a keyboard which works in unison with a compatible operating program to produce piano chords is provided.

(FIGS. 1, 4 and 5 top view) A rectangular bar 23 is fastened lengthways on top of two keyboard actuator switches 30 that have been strategically mounted as a pair upon a (FIG. 1 top view) keyboard 21. Any style of actuator switches 30 can be placed in any position, at any angle, anywhere on the keyboard. These two (FIG. 3 top view) actuator switches 30 and the (FIG. 1 top view) rectangular bar 23 work together in unison for input purposes. The (FIG. 6 side view) rectangular bar 23 is fastened on top of each one of the (FIGS. 10, 11 and 12 side view) actuator switches 36a and 36b by a flexible fastener means such as a (FIG. 7 side view) swivel fastener 32a and 32b or by a (FIG. 8 side view) hook and loop fastener 33a, 33b, 34a and 34b or by a (FIG. 9 side view) flexible membrane fastener 35a and 35b with each one of the (FIGS. 10,11 and 12 side views) actuator switches 36a and 36b being strategically located directly underneath each opposing end of the (FIG. 6 side view) rectangular bar 23. This conglomeration is referenced as a piano chord producing bar.

The flexible fastening system that is incorporated into the piano chord producing bar conglomeration allows the piano chord producing bar to be pressed down on either one of it's two end's sides without causing the other end's side of the bar to be pressed down at the same time. The piano chord producing bar can be pressed down in it's middle to play both of it's two end's sides at the same time.

(FIG. 3 top view) Panel lights 31 are flush-mounted on the keyboard's surface underneath each piano chord producing bar in a strategic location between the two (FIG. 3 top view) actuator switches 30. These panel lights are used to illuminate the keyboard and show which piano chord producing bars to depress when the keyboard is running in an Auto-accompaniment mode.

Each individual piano chord producing bar can be programmed to play in any octave, in any key of music, in any amount of musical instrument's voices and in any amount of full or partial piano chords. The piano chord producing bar conglomeration can be made to any length, width and height and placed at any angle, anywhere on a keyboard. (FIG. 1 top view) The rectangular bar 23 can be of any thickness, shape or dimensions and composed of any materials or compositions with any kind of colors, design patterns, surfaces and textures.

Piano chord producing bars are set by default within their operating program to play only one music note per each one of it's two end's sides. This is to allow the keyboard player to play only one music note at a time when it is being depressing down on only one of the two end's sides of the piano chord producing bar. Piano chord producing bars which are played in this original default setting can only play partial piano chords when that they are fully depressed. This is because of the fact that a lot of piano chords use three to four music notes to play their full chord.

There are complex piano chords which require more than four music notes to properly play their full chord structure. These complex types of piano chords require having to utilize two octaves on a keyboard to properly play their full piano chord. Being able to individually program each piano chord producing bar makes producing these complex chords possible.

(FIG. 16 side view) is a drawing that illustrates how that a piano chord producing bar that is programmed to play partial piano chords in a sixth or seventh position key of music, can also be individually programmed to play a full piano chord by having the operating program electronically “compress” the piano chord producing bar to play two properly synchronized sequenced music notes on each one of it's two end's sides. Thus when the piano chord producing bar is fully depressed down in it's middle it will play the full piano chord. This is possible to do with piano chords that require four music notes to produce a full chord.

Piano chords that are played in a major or minor key of music that does not have a sixth or seventh position usually only require the use of three music notes. Since three is an odd number a piano chord producing bar would have to be electronically “compressed” to play three properly synchronized sequenced music notes on each one of it's two end's sides to properly “balance the actions” of the compressed piano chord producing bar. This will make the piano chord producing bar play a full chord on one of it's two end's sides when it is pressed down on only one of it's two end's sides. When the piano chord producing bar is fully pressed down in the middle it will play two full piano chords in two full octaves at the same time.

Piano chord producing bars are plurally arranged in horizontal parallel cross bond rows which extend lengthways from the left side to the right side of the keyboard.

Each one of the individual rows of piano chord producing bars is programmed to play piano chords and music notes in the particular key of music and in all the musical instrument's voices that are specifically assigned to the individual row. This allows the keyboard player to quickly change the key of music and the musical instrument's voices of the piano chords on each one of it's rows during performances by utilizing pre-set sequences. Pre-set sequences can program more than one individual row to play piano chords and music in the same key of music. This can allow the keyboard player to perhaps play two rows of piano chord producing bars that are programmed to play in the same key of music, to perhaps play of the one of the two rows in a piano voice, and the other one of the two rows to play in a violin voice. All individual rows of piano chord producing bars have the option to be automatically tuned into a different key of music by the Auto-accompaniment feature as the auto-accompaniment changes bass rhythms into a different key of music. This allows the keyboard player to keep playing on the same row of piano chord producing bars without having to change rows to produce the changed key of music of the piano chord. This also allows the keyboard player to play a multitude of different musical instrument's voices on several rows at the same when they are automatically tuned to a different key of music by the auto-accompaniment program.

(FIG. 1 and FIG. 2 top view) Keyboards 21 and 24 may contain any amount of individual rows of piano chord producing bars. More rows of piano chord producing bars allows for more different key of music piano chords, music notes and musical instrument's voices to be available for playing during performances.

(FIG. 1 and FIG. 2 top view) Keyboards 21 and 24 may contain any amount of piano chord producing bars per row of piano chord producing bars. This gives the keyboard more full octaves to play without having to “compress” piano chord producing bars. And it allows the piano chord producing bars that play partial piano chords to only play one music note at a time when that they are depressed down on only one of either one of their ends.

The keyboard may be covered with a protective membrane. This could also make it easier for some keyboard players to play the keyboard.

(FIG. 1 top view) Piano Chord Producing Bars keyboard systems with their compatible operating programs can be incorporated into a controller keyboard 21 for input into various devices. Note: The controller keyboard shown in (FIG. 1 top view) is a generic representation of an input controller keyboard utilizing piano chord producing bars and their compatible operating program. It is not intended as a direct design of how a controller keyboard will actually be produced.

Piano Chord Producing Bars keyboards with their compatible operating programs can be incorporated into (FIG. 2 top view) electronic keyboard musical instruments 24. Note: The electronic keyboard musical instrument shown in (FIG. 2 top view) is a generic representation of a musical instrument utilizing piano chord producing bars and their compatible operating program. It is not intended as a direct design of how an electronic keyboard musical instrument will actually be produced.

(FIG. 3 top view) A keyboard controller 29 is shown with large actuator switches 22, paired together actuator switches 30 and panel lights 31. This figure shows a controller keyboard which is set-up for the installation of rectangular bars 23 to be properly placed on top of the paired together actuator switches. Note: The electronic keyboard musical instrument shown in (FIG. 3 top view) is a generic representation of a musical instrument utilizing piano chord producing bars. It is not intended as a direct design of how a controller keyboard will actually be produced.

(FIG. 4 top view and FIG. 5 top view) Show paired together actuator switches 30, panel lights 31 and rectangular bars 23. These figures are included to show how the rectangular bars are properly placed upon the actuator switches in the proper sequences.

(FIGS. 6 thru 12 side view) show a side view of the rectangular bar 23 and how it may be attached to any of various sets of flexible fasteners 32a and 32b; 33a and 33b; 34a and 34b; or 35a and 35b. Then one of the various sets of fasteners can be attached to actuator switches 36a and 36b to make up the conglomeration that is called a Piano Chord Producing Bar.

(FIG. 13 top view) shows a section of a keyboard that contains paired together actuator switches 37a and 37b that have been electronically numbered within the operating program for the systems reference numbering technique. Panel lights 31 are shown in their placement between the actuator switches. Note: This is only a general example of a keyboard layout. Keyboards using these systems can incorporate any amounts of piano chord producing bars and rows of piano chord producing bars.

(FIG. 14 top view) is a drawing that shows a section of a keyboard that has electronically reference numbered rectangular bars 38 for the operating systems recognition of the reference numbered piano chord producing bars location on the keyboard. Because the letters A, B, C, D, E, F and G are base reference letters for various music notes, musical keys and chord compositions the piano chord producing bars operating program utilizes the capital letters M, N, O, P, Q, R, S, T, U, V, W, X, Y and Z to show the placement of piano chord producing bars in a row. Letter references begin from the left side of each row and are in the same place for each row. Each reference number for piano chord producing bars positions in each individual row is preceded by the number of the row that the particular piano chord producing bar is located in. (FIG. 14 top view) is a drawing of an example showing a particular representation of a four-rowed, seven piano chord producing bars per row keyboard. Note: This is only a general example of a keyboard layout. Keyboards using these systems can incorporate any amounts of piano chord producing bars and rows of piano chord producing bars.

(FIG. 15 text) These are examples of instruction sheets that are used as guides for the proper assignments of the notes of various chords to each actuator switch 30 that is contained within a piano chord producing bar.

(FIG. 16 side view) is a drawing that shows a side view of how the operating program electronically “compresses” assigned notes into a piano chord producing bar. Because each individual piano chord producing bar can be programmed to play in as many piano chords as desired, electronic keyboard musical instruments and controller keyboards using this technique can utilize more octaves per each individual row.

The piano chord producing bars operating program utilizes a low to high octave system comprised of seven total octaves.

(FIG. 2 top view) Keyboards 24 that are manufactured with a fourteen piano chord producing bars per row system can play all the piano chords that can be normally played in seven octaves on a conventional seven octave piano. And this can be accomplished without having to use the “compression technique” that has been described in this disclosure. This is because that two piano chord producing bars played which are played together in unison can play a particular piano chord in one octave. Some complex piano chords are composed as to require two octaves on any piano to properly play their chord.

The piano chord producing bar conglomeration and it's operating program which are both described in this disclosure are engineered to work together in unison to maximize the full operations of this new method for the production and playing of piano chords with multiple musical instrument's voices in synchronized rows of piano chord producing bars.

The piano chord producing bars operating program is basic in design and tailored to be easily adaptive into music producing software programs that are currently being used in the operating systems of computing devices, modern electronic pianos, music writing and publishing systems, electronic musical systems and various other electronic musical instrument devices. Being able to utilize the effects, running operations, musical instrument's voices and other features that are currently incorporated into various music producing software programs makes the piano chord producing bars system more cost effective and desirable for adaptation into electronic musical producing devices, electronic musical instruments, computing system devices, music writing and publishing programs and various other systems that are being manufactured world wide.

Piano chord producing bars can also play piano chords and music notes on touch screen devices by downloading the piano chord producing bars operating program application onto a touch screen device. The mobile application will display and correspond to the piano chord producing bars on the device's touch screen When a displayed piano chord producing bar is touched in the middle it will play both of it's ends at the same time. When the displayed piano chord producing bar is touched on one of it's ends it will play the notes that are assigned to the touched end of the piano chord producing bar. When two piano chord producing bars which are positioned right next to each other are both touched together at the same time on their ends that are positioned right next to each other they will produce partial or full piano chords.

Piano chord producing bars keyboards can utilize actuator switches which are of any style, of any size and of any kind of mechanical mechanism. Actuator switches can be operated together with any type of mechanical means on any type of platform.

Piano Chord Producing Bars keyboards with their compatible operating programs can be incorporated into electronic keyboard musical instruments.

Piano Chord Producing Bars keyboards with their compatible operating programs can be incorporated into controller keyboards for input into various devices.

Piano chord producing bar conglomerations can be easily installed onto input keyboards that are already in manufacture.

Controller keyboards using piano chord producing bars are easy and inexpensive to manufacture and cost effective to customers because using them with a personal computer and sound system eliminates the need to purchase a bulky, expensive controller piano or electronic piano musical instrument.

The (FIG. 1 top view) rectangular bars 23 of the piano chord producing bars can be made in any color or design patterns for the easy playing of songs which have words that are written in color or design patterns to show the keyboard player the proper rows to play for the proper key of music for each word in the song. The rectangular bars can also be textured for touch place referencing to aid the visually impaired.

What is claimed is:

1. (canceled)

2. An apparatus for producing piano chords, comprising:
a keyboard controller having a top surface, a bottom surface opposite the top surface, and a periphery formed by a top side, a bottom side, a first lateral side, and a second lateral side; and
a plurality of horizontal rows disposed on the top surface extending from the first lateral side to the second lateral side, each of the plurality of horizontal rows comprising a plurality of piano chord producing bars, each of the plurality of piano chord producing bars comprising:
a pair of actuator switches disposed on the top surface of the keyboard controller, the pair of actuator switches comprising a first actuator switch and a second actuator switch,
a first flexible fastener coupled to the first actuator switch,
a second flexible fastener coupled to the second actuator switch, and
a lengthways-positioned bar coupled to each of the first flexible fastener and the second flexible fastener.

3. The apparatus of claim 2, wherein the first flexible fastener and the second flexible fastener are coupled to opposing ends of the lengthways-positioned bar.

4. The apparatus of claim 2, wherein the lengthways-positioned bar extends in a longitudinal direction from the first lateral side to the second lateral side.

5. The apparatus of claim 2, each of the plurality of piano chord producing bars further comprising a light coupled to the top surface and disposed between the first actuator switch and the second actuator switch.

6. The apparatus of claim 5, wherein the light is disposed between the lengthways-positioned rectangular bar and the keyboard controller.

7. The apparatus of claim 2, the flexible fastener comprising a swivel fastener, a hook and loop fastener, a flexible membrane, or a combination thereof.

8. The apparatus of claim 2, wherein each piano chord producing bar is configured to engage at least one of the first actuator switch or the second actuator switch upon manual depression of the piano chord producing bar.

9. The apparatus of claim 2, the plurality of horizontal rows further comprising a staggered formation wherein each of the plurality of horizontal rows comprises a horizontal offset from each adjacent horizontal row.

10. The apparatus of claim 2, wherein the first actuator switch is configured to operate in unison with the second actuator switch to input information to a keyboard operating program.

11. The apparatus of claim 2, wherein each piano chord producing bar is tunable to play synchronized full or partial piano chords.

12. The apparatus of claim 2, wherein the first actuator switch and the second actuator switch of at least one of the plurality of piano chord producing bars are each configured to output at least one music note.

13. The apparatus of claim 12, wherein each music note corresponding to the first actuator switch is different from each music note corresponding to the second actuator switch.

14. The apparatus of claim 2, wherein the first actuator switch and the second actuator switch of at least one of the plurality of piano chord producing bars are each configured to output a single music note.

15. The apparatus of claim 2, wherein the first actuator switch and the second actuator switch of at least one of the plurality of piano chord producing bars are each configured to output a plurality of music notes.

16. The apparatus of claim 15, wherein the first actuator switch and the second actuator switch are each configured to output at least three music notes.

17. The apparatus of claim 2, wherein each of the plurality of piano chord producing bars is manually depressible.

18. The apparatus of claim 2, wherein two of the plurality of piano chord producing bars are configured to collectively produce a full 4-notes single octave chord.

19. The apparatus of claim 2, wherein at least one of the plurality of horizontal rows comprises seven piano chord producing bars.

20. The apparatus of claim 2, wherein at least one of the plurality of horizontal rows comprises fourteen piano chord producing bars.

21. The apparatus of claim 2, wherein the keyboard controller is integrated into an electronic musical instrument keyboard.
